(19) United States
(12) Patent Application Publication
(10) Pub. No.: US 2026/0163744 A1
(43) Pub. Date: Jun. 11, 2026

(54) CHIP AND METHOD FOR CHIP AUTHENTICATION

(71) Applicant: SAMSUNG ELECTRONICS CO., LTD., SUWON-SI (KR)

(72) Inventor: Peng Wang, Xi'an (KR)

(21) Appl. No.: 19/009,293

(22) Filed: Jan. 3, 2025

(30) Foreign Application Priority Data
Dec. 9, 2024 (CN) 202411803789.4

(51) Int. Cl. H04L 9/32

(52) U.S. Cl. CPC H04L 9/3247

(57) ABSTRACT

An authentication method performed by a chip includes receiving an authentication request from a debugger; performing an offline authentication based on an authentication license in response to the authentication request being an offline authentication request, wherein the authentication license includes access control information of a chip and a user stamp generated based on user information; and enabling access of the debugger to a resource of the chip based on the access control information, wherein the performing of the offline authentication comprises: transmitting an offline challenge to the debugger, wherein the offline challenge is generated by the chip based on an identifier of the chip; receiving, from the debugger, a second signature corresponding to the offline challenge; and verifying the second signature based on the offline challenge, using the user stamp included in the authentication license as an offline authentication public key.

### CROSS-REFERENCE TO RELATED APPLICATION

This application is based on and claims priority under 35 U.S.C. § 119 to Chinese Patent Application No. 202411803789.4, filed on Dec. 9, 2024, in the China National Intellectual Property Administration, the disclosure of which is incorporated by reference herein in its entirety.

### BACKGROUND

### 1. Technical Field

Some example embodiments relate to a method for chip authentication, and more particularly, to a method for authenticating secure debugging of a chip.

### 2. Discussion of Related Art

Many integrated circuits or chips have debug interfaces to facilitate development and maintenance. A debugger may be connected to a debug interface of a chip, and may run a debugging software tool to obtain code and data of the chip, control the operation of the code, and access and modify hardware resources such as registers, memory, or input/output (I/O). However, the debug interface may represent a security rick, which may be used to attack the hardware and software of the chip.

### SUMMARY

This summary is provided to introduce a selection of concepts in a simplified form that are further described in the Detailed Description. This summary is not intended to identify key features and/or essential features of the claimed subject matter, nor is it intended to be used as an aid in determining the scope of the claimed subject matter.

According to an example embodiment of the present application, an authentication method performed by a chip includes receiving an authentication request from a debugger; performing an offline authentication based on an authentication license in response to the authentication request being an offline authentication request, wherein the authentication license includes access control information of a chip and a user stamp generated based on user information; and enabling access of the debugger to a resource of the chip based on the access control information, wherein the performing of the offline authentication comprises: transmitting an offline challenge to the debugger, wherein the offline challenge is generated by the chip based on an identifier of the chip; receiving, from the debugger, a second signature corresponding to the offline challenge; and verifying the second signature based on the offline challenge, using the user stamp included in the authentication license as an offline authentication public key.

According to an example embodiment of the present application, a method of authenticating a chip includes: receiving, by the chip, an authentication request from a debugger; performing an online authentication, in response to the authentication request being an online authentication request; and enabling access of the debugger to a resource of the chip based on the online authentication, wherein the performing of the online authentication comprises: transmitting an online challenge from the chip to the debugger, wherein the online challenge is generated based on an identifier of the chip; receiving, by the chip from the debugger, an authentication license and a first signature generated by a server; verifying, by the chip, the first signature using a pre-installed online authentication public key; and storing, by the chip, the authentication license and the first signature in an off-chip memory, and storing the online challenge as a cycle tag in an on-chip memory, in response to the verifying of the first signature.

According to an example embodiment of the present application, a chip comprising: an on-chip memory; an authentication unit configured to receive an authentication request from a debugger and perform an offline authentication based on an authentication license generated through an online authentication, in response to the authentication request being an offline authentication request, wherein the authentication license includes access control information of a chip and a user stamp generated based on user information; and a global access controller configured to enable access rights of the debugger to a resource of the chip based on the access control information, after the authentication is successful, wherein for the performing of the offline authentication, the authentication unit is configured to: transmit an offline challenge to the debugger, wherein the offline challenge is generated based on an identifier of the chip; receive, from the debugger, a second signature corresponding to the offline challenge; and verify the second signature based on the offline challenge, using the user stamp included in the authentication license as an offline authentication public key.

A method and system for chip authentication according to some example embodiments of the inventive concept may implement an online/offline dual-mode authentication, which is independent of a proxy and a local database, and may implement authentication and authorization user identity-based, revocation of access rights and defense against replay attacks in both online and offline scenarios.

Other aspects and/or advantages of inventive concepts will be partially described in the following description, and part will be clear through the description and/or may be learn through the practice of various example embodiments.

### BRIEF DESCRIPTION OF THE DRAWINGS

The above and other objects, features and advantages of the present disclosure will become clearer through the following detailed description together with the accompanying drawings in which:

FIG. 1 is a diagram illustrating an example of a chip authentication system;

FIG. 2 is a diagram illustrating an example of a proxy mode for debugging authentication of a chip;

FIG. 3 is a diagram of a dual-mode authentication method according to an example embodiment of the present disclosure;

FIG. 4 is a diagram of a dual-mode authentication system according to an example embodiment of the present disclosure;

FIG. 5 is a flowchart of an online authentication method according to an example embodiment of the present disclosure;

FIG. 6 is a diagram illustrating an example of an authentication license according to an example embodiment of the present disclosure;

FIG. 7 is a diagram of an online authentication method according to an example embodiment of the present disclosure;

FIG. 8 is a diagram illustrating an example of generating an authentication license according to an example embodiment of the present disclosure;

FIG. 9 is a diagram illustrating an example of signing an authentication license according to an example embodiment of the present disclosure;

FIG. 10 is a diagram illustrating an example of verifying an authentication license according to an example embodiment of the present disclosure;

FIG. 11 is a flowchart of an offline authentication method according to an example embodiment of the present disclosure;

FIG. 12 is a flowchart of an offline authentication method according to another example embodiment of the present disclosure;

FIG. 13 is a diagram of an offline authentication method according to an example embodiment of the present disclosure;

FIG. 14 is a diagram illustrating operations of a debugger during the offline authentication according to an example embodiment of the present disclosure;

FIG. 15 is a diagram illustrating operations of a chip during the offline authentication according to an example embodiment of the present disclosure;

FIG. 16 is a diagram illustrating an example of a chip according to an example embodiment of the present disclosure;

FIG. 17 is a diagram illustrating an example of logic of an expiration detector according to an example embodiment of the present disclosure; and

FIG. 18 is a diagram illustrating an example of authentication cycles according to an example embodiment of the present disclosure.

### DETAILED DESCRIPTION

The following detailed description is provided to assist the reader in gaining a comprehensive understanding of methods, apparatuses, and/or systems described herein. However, various changes, modifications, and equivalents of methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing methods, apparatuses, and/or systems described herein that will be apparent after an understanding of the disclosure of this application.

The following structural or functional descriptions of examples disclosed herein are merely intended for the purpose of describing the examples and the examples may be implemented in various forms. The examples are not meant to be limited, but it is intended that various modifications, equivalents, and alternatives may also be covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of normal skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof may be omitted or simplified.

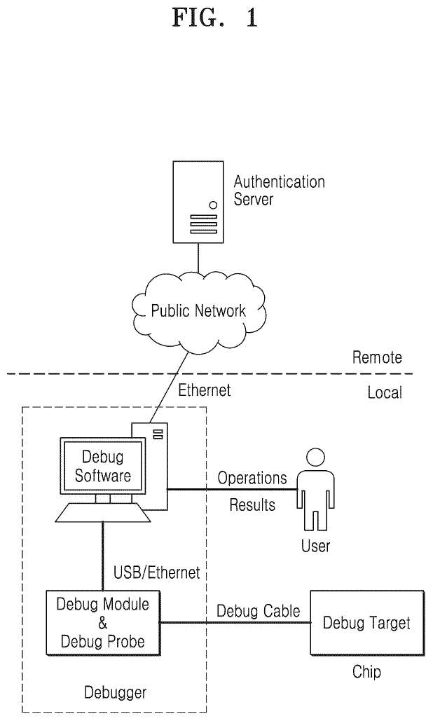

FIG. 1 is a diagram illustrating an example of a chip authentication system.

Referring to FIG. 1, the chip authentication system may at least include a server (or authentication server), a debugger (or debugging equipment), and a chip. A user may interact with the chip authentication system. The server may store information such as user identifier (user ID), password, an identifier of the chip (chip ID), key and access rights. The server may directly determine whether the user has the right to access chip resources. The server is disposed remotely, and is controlled by a trusted party (for example, a chip manufacturer). The debugger may refer to all equipment and corresponding software tools used to debug chips. The one who uses the debugger is the user, and an object of debugging is the chip. Resources to be protected from access may be present in the chip. The debugger may be connected with the server through a public network. The debugger may be connected with the user through a debug interface and cables.

Debugging and authentication of a chip may include an offline authentication mode, an online authentication mode, and a proxy mode.

The offline authentication mode may be a mode in which both the debugger and the chip, which is the debugging object, perform authentication. The chip may determine the legitimacy of the debugger by verifying whether the debugger has a certain key, for example, password or private key. For a legitimate debugger, the chip may grant access to the debug interface. The offline authentication can be implemented easily and has low-cost, but it may be difficult to achieve fine-grained access distribution and allocate different access rights to different users. For example, the chip may store a limited amount of user information and authority information, and may not have an ability for dynamic updates and maintenance.

The online authentication mode may include a third role in which the server may be responsible for authentication and authorization. The server may store user information or user credentials of the user, which may be referred to as a debuggee, chip information (chip ID) and corresponding access rights. The user information or user credentials may include, for example, a user ID or password. The server may assign different rights to different debuggees or users to implement fine-grained debugging rights control. For example, the access rights of the chip may be refined to a specific processor core, a specific memory region, a specific bus, and a specific input/output (I/O).

Although the online authentication may be used, the debugger or debugging equipment may need to access a server for each online authentication. However, access to a server may not be available in some practical application scenarios. For example, for the sake of information confidentiality, the debugger or debugging equipment and the target chip may be located in an environment with an internal network and/or without a network, which may not have access to an external server, which may restrict the practical application of an online mode.

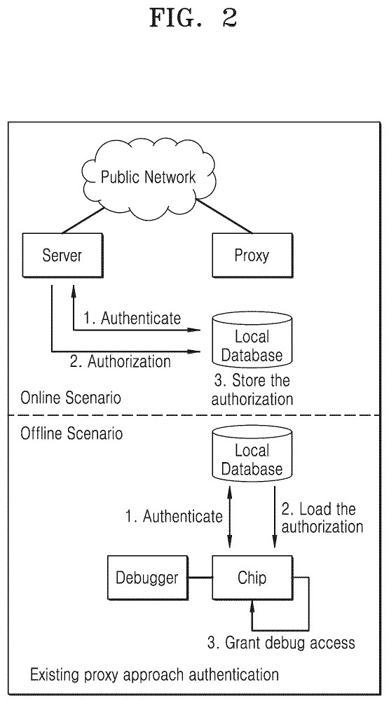

The proxy mode may reduce dependence of the online mode on a remote server. FIG. 2 is a diagram illustrating an example of a proxy mode for debugging authentication of a chip.

A proxy that can access the external network may be provided in the debugging environment. The proxy may connect to the remote authentication server and may store the obtained authorization information in a local database. During authorization, the authorization information stored in the local database may be provided to the chip, and a connection to the remote authentication server may not be established.

A conventional proxy mode may fail to support user-oriented authorization in offline scenarios. Because the authorization information stored in the local database is not related to the user, anyone who may debug the chip using the debugging environment in the offline scenario may obtain the same debugging rights.

The conventional proxy mode may fail to revoke authorization. In the conventional proxy mode, once the remote authentication server distributes the authorization information to the local proxy, the information may be permanently stored in the local database, and then the local database may arbitrarily grant the debugger access without the control of the remote server. Therefore, in the conventional proxy mode, the authorization of the chip may have no validity period and may not be revoked.

The conventional proxy mode may fail to resist a replay attack against authorization information in offline scenarios. A reply attack refers to a attacker deceiving the debugging target (chip) using previous authorization information records.

In addition, the conventional proxy mode may further use the proxy and database as the third party, and may not support a real offline scenario, which may limit the application scenarios of the conventional proxy mode.

In order to make the debugging of chips safer and support various debugging environments, embodiments of the present invention may provide a user-oriented online-offline chip authentication method.

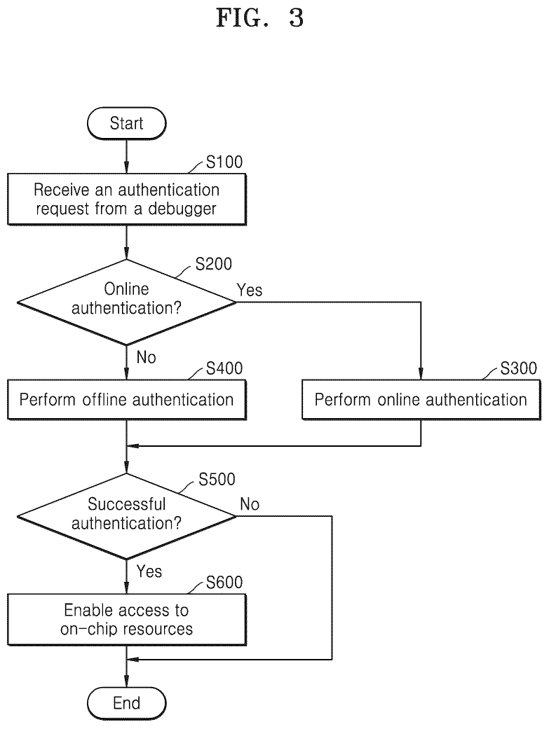

FIG. 3 is a diagram of a dual-mode authentication method according to an example embodiment of the present disclosure.

When a chip is in an unauthenticated state, an online authentication may be performed and an authentication license may be generated. The authentication license may be transmitted to the chip. The authentication license may be used for authenticating and authorizing the user in an offline authentication. Thereafter, the offline authentication may be performed in a subsequent authentication. For example, an initial online authentication may be performed to generate the authentication license, which may be used in a subsequent offline authentication.

Referring to FIG. 3, in step 100, an authentication request may be received from a debugger. In an example, the user may input the user information to the debugger and an indication of authentication mode. The user information may include user ID and/or password. However, the user information is not limited thereto, and may include additional information. The Authentication mode may include an online mode or an offline mode. At step 100, the debugger may transmit the authentication request to the chip based on the authentication mode received from the user.

In step S200, the authentication request may be parsed to determine a mode indicated by the user. For example, the authentication request may be specified to be the online authentication mode or the offline authentication mode.

In a case that the authentication request is determined as the online authentication request in step S200, the online authentication may be performed in step S300. Specifically, an online authentication protocol may be implemented by the server, the debugger, and the chip. The online authentication may implement an authentication for the user using the server and an authentication for the server using the chip. In the online authentication, the server may generate an authentication license License and a cycle tag Cycle Tag. The server may transmit the authentication license License and the cycle tag Cycle Tag to the chip as the data for authenticating and authorizing the user in the offline authentication, wherein the authentication license includes the user's access rights, time limit (or validity period parameters), and a user stamp.

In a case that the authentication request is determined as the offline authentication request in step S200, the offline authentication may be performed in step S400 based on the authentication license generated through the online authentication, previously performed in step S300. In the offline authentication process in step S400, an offline authentication protocol may be executed by both the debugger and the chip. The server may not be included in the performance of the offline authentication process in step S400. The chip may authenticate and authorize the user offline according to the authentication license. The chip may authenticate and authorize the user offline according to the authentication license and a fine-grained access rights distribution may be implemented in offline scenarios. The chip may authenticate and authorize the user offline according to the authentication license and replay attacks against authorization may be defended by the cycle tag.

In step S500, the chip may determine whether the online/offline authentication performed at step S300 or step S400 is successful. In response to successful authentication, in step S600, the chip may enable access rights of resources within the chip based on the access control information. Otherwise, in response to a failed authentication, the chip may disable the access rights of the resources within the chip.

In an example, in response to the online authentication being successful, the chip may store the authentication license and a signature corresponding to the authentication license, and may reset a count CNT of an offline authentication counter. In another example, in response to the offline authentication being successful, the chip may increase the count CNT of the offline authentication counter by 1, for an authorization expiration and revocation mechanism in the offline mode.

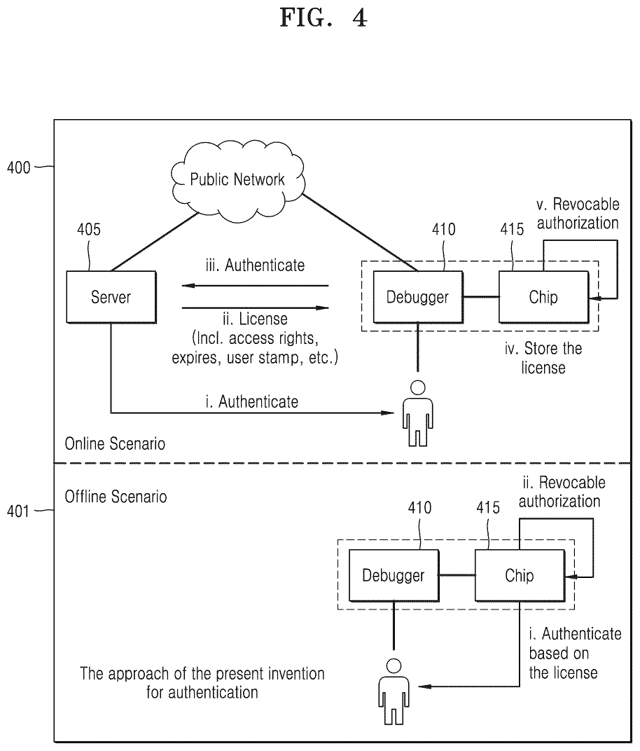

FIG. 4 is a diagram of a dual-mode authentication system according to an example embodiment of the present disclosure.

In the online authentication scenario 400, a server 405 may authenticate the user first. When the user authentication is successful, the server 405 may transmit the authentication license to a debugger 410. Thereafter, a chip 415 may authenticate the server 405, and may store the authentication license after successful authentication.

In the offline scenario 401, the chip 415 may authenticate the user based on the authentication license to implement a user-oriented authorization.

Regardless of online authentication or offline authentication, after successful authentication, an authentication unit may transmit parameters for detecting expiration and may revoke the authorization when expired access rights are detected. The authentication unit may be a module responsible for authentication in the chip. The parameters for detecting expiration may include, for example, single power-on time t of the chip and the offline authentication count CNT.

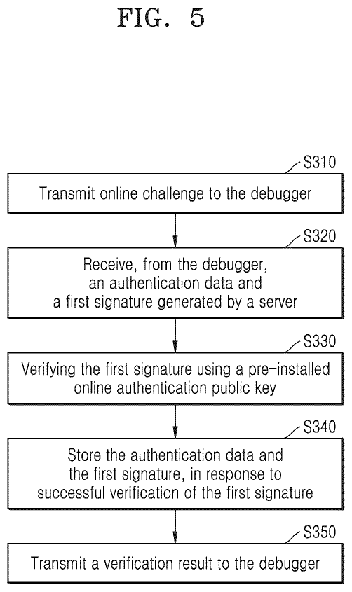

FIG. 5 is a flowchart of an online authentication method according to an example embodiment of the present disclosure. The flowchart in FIG. 5 corresponds to step S300 in FIG. 3.

Referring to FIG. 5, when the online authentication request is received from the debugger, the chip may transmit an online challenge to the debugger in step S310. In an example, the online challenge may be a value generated based on the chip ID.

The debugger may forward the online challenge to the server together with the user information (for example, the user ID and password). The server may generate the authentication license according to the user information, and may sign a concatenating result of the authentication license and the online challenges to form a first signature, using an online authentication private key. The server may forward the authentication license and the first signature to the debugger.

In step S320, the chip may receive, from the debugger, the authentication license and the first signature.

In step S330, the chip may verify the first signature using a pre-installed online authentication public key.

In step S340, in response to successful verification of the first signature, the chip may store the authentication license and the first signature.

In step S350, the chip may transmit a verification result to the debugger. When the online authentication is successful, the chip may enable the access to a corresponding resource within the chip according to the access rights. For example, the chip may update access rights of a user to access one or more resources of the chip.

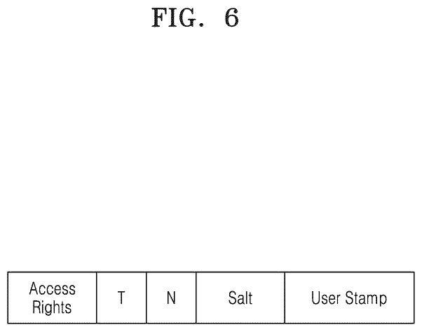

FIG. 6 is a diagram illustrating an example of an authentication license according to an example embodiment of the present disclosure.

Referring to FIG. 6, the authentication license may include access control information of the chip and a user stamp. The authentication license may further include data for performing a salting function. For example, the authentication license may include access rights, validity period parameters (T and N), salt (Salt) data, and a user stamp. For example, the access control information of the chip may include the access rights and the validity period parameters (T and N). In another example, the access control information of the chip may include access rights, validity period parameters (T and N), salt (Salt) data. The arrangement of the authentication license depicted in FIG. 6 is exemplary, and portions of the authentication license may be arranged in any order.

The access rights may refer to the access rights of the user to the hardware resources of the chip, which may be determined by the server searching right control policy according to the user information (e.g., user ID) and the chip information (e.g., chip ID) participating in authentication. The chip may enable or disable debugging access of corresponding hardware resources according to the access rights. The corresponding hardware resources may include, but are not limited to processors, memories, I/O, or peripheral devices.

The validity period parameters may include T and N, wherein a first validity period parameter T may represent an allowable single power-on time of the chip, and a second validity period parameter N may represent a number of times that an offline authentication may be allowed. The validity period parameters T and N may be used to implement the revocation of authorization. The first and second validity period parameters T and N may be configured by the server as authorization policy and stored in the database of the server.

The server may generate a random number, and generate a salt by concatenating the random number with current chip ID. The salt may include data that may be used as an additional input. For example, the salt may include random data that may be used as an additional input. The salt may be used in key generation of the offline authentication, and may be used to protect against a rainbow table attack. The server may not need to store the salt.

The user stamp may be a public key. The user stamp may be generated by the server according to the user information. The user stamp may be generated by the server according to the user information to verify the signature. The user stamp may cause authorized access rights to correspond to the user identity, so that the user identity matching the corresponding authorization may be verified during the offline authentication, and thus object-oriented offline authentication may be achieved.

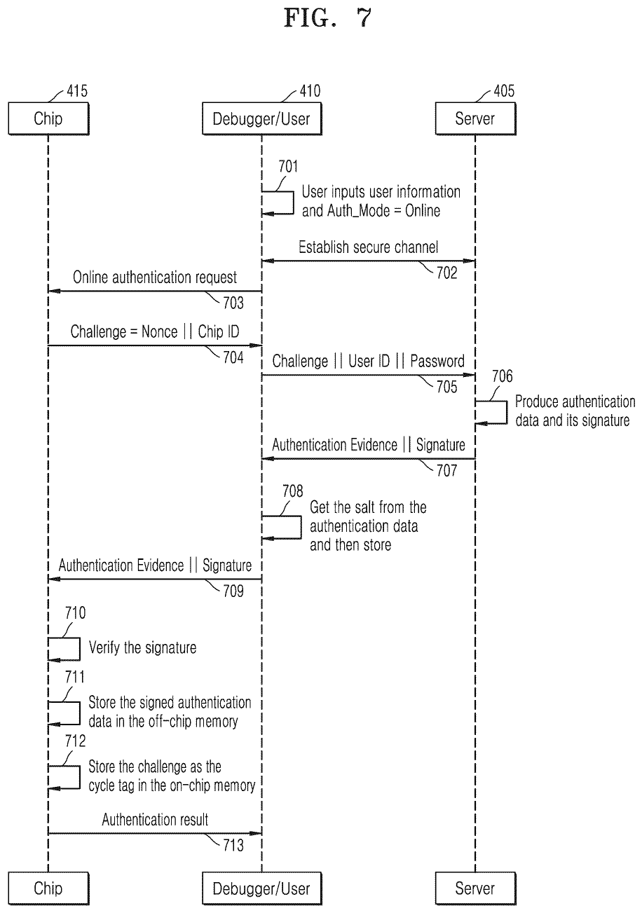

FIG. 7 is a diagram of an online authentication method according to an example embodiment of the present disclosure.

The online authentication may be performed using a chip 415 that includes a pre-installed online authentication public key, or a hash value of the public key. Such an operation may be carried out in the manufacture of the chip. The server 405 may store a private key corresponding to the public key.

Referring to FIG. 7, in step 701, a debugger 410 may receive the user information and the authentication mode Auth_Mode from a user. The user information may include a user ID and a password, but this is only an example, and the present disclosure is not limited thereto. In response to the authentication mode being the online mode, the debugger 410 may determine that the user selects the online authentication.

In step 702, the debugger 410 may establish a secure channel with the server 405 through a secure transport protocol (e.g., TLS or SSH). In step 703, the debugger 410 may transmit the online authentication request to the chip 415.

In step 704, the chip 415 may generate a random number Nonce. The chip 415 may concatenate the random number Nonce with it with the chip ID to generate the online challenge Challenge, and may transmit the Challenge to the debugger 410.

In step 705, the debugger 410 may generate a request message by concatenating the Challenge with the user ID and password, and may transmit the request message to the server 405. Since the secure channel has been established between the debugger 410 and the server 405, the user's password may not be revealed.

In step 706, the server 405 may authenticate the user according to information of registered users in its database, generate the authentication license and its signature, and transmit the authentication license and its signature to the debugger 410.

In step 707, the debugger 410 may receive the authentication license and its signature from the server 405. In step 708, the debugger 410 may obtain a salt from the authentication license, and may store the salt for the generation of key materials during the offline authentication. In step 709, the debugger 410 may transmit the authentication license and its signature to the chip 415.

In step 710, the chip 415 may verify the received authentication license using the online authentication public key.

If the verification is successful, in step 711, the chip 415 may store the received authentication license and signature in an off-chip memory for the offline authentication. In step 712, the chip 415 may store the Challenge in step 704 to an on-chip memory as a cycle tag Cycle Tag, so as to defend against replay attacks during the offline authentication. In step 713, the chip 415 may feed the authentication result back to the debugger 410, and the online authentication may end. If the verification is successful, the chip 415 may enable the access rights of the corresponding resources according to the access rights information.

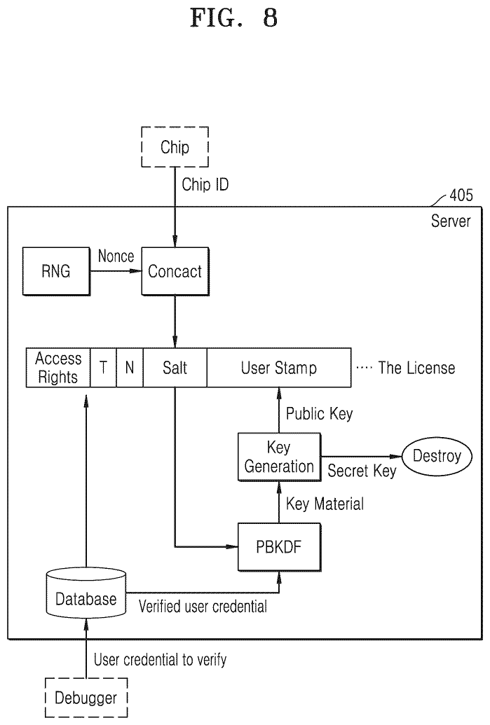

FIG. 8 is a diagram illustrating an example of generating an authentication license according to an example embodiment of the present disclosure. Operations in FIG. 8 may correspond to a portion of generating the authentication license in step 706 in FIG. 7.

Referring to FIG. 8, when receiving the user information (e.g., user ID and password, etc.) from the debugger, the server may query the database for the access rights to the chip and the validity period parameters (T and N) corresponding to the user ID.

The server may generate the random number Nonce, and may concatenate the random number Nonce with the current chip ID to generate a salt Salt. That is, the salt Salt may be written as Salt=Nonce∥Chip ID.

In addition, the server may generate the user stamp using the user information. In an example, the server may generate key material through a password-based key derivation algorithm (e.g., password-based key derivation function 2, PBKDF2) according to the currently authenticated user ID, password, and the generated salt. The server may generate a pair of public key and private key as the offline authentication public key (offline-pk) and the offline authentication private key (offline-sk), based on the key material and a signature algorithm. The offline authentication public key may be stored in the authentication license as the user stamp, and the offline authentication private key may be destroyed by the server.

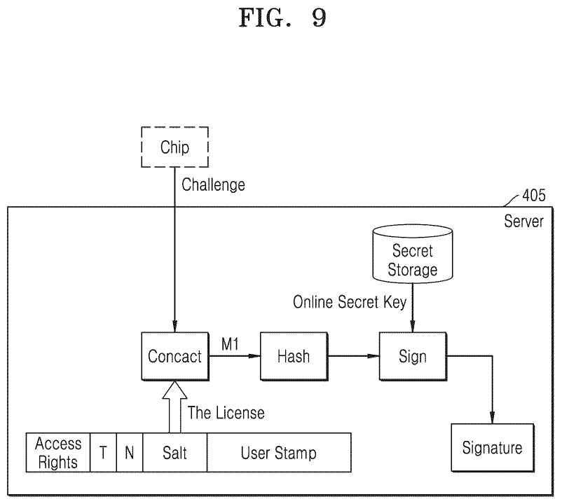

FIG. 9 is a diagram illustrating an example of signing an authentication license according to an example embodiment of the present disclosure. Operations in FIG. 9 may correspond to a portion of generating the signature in step 706 in FIG. 7.

Referring to FIG. 9, the server may concatenate the generated authentication license and the online challenge Challenge received from the chip, to obtain a concatenating result M1. The concatenating result M1 may be written as M1=Challenge∥License. The server may sign the hash value of M1 using the online authentication private key (online-sk) as follows:
Signature=Sign(online-sk, Hash(M1)).

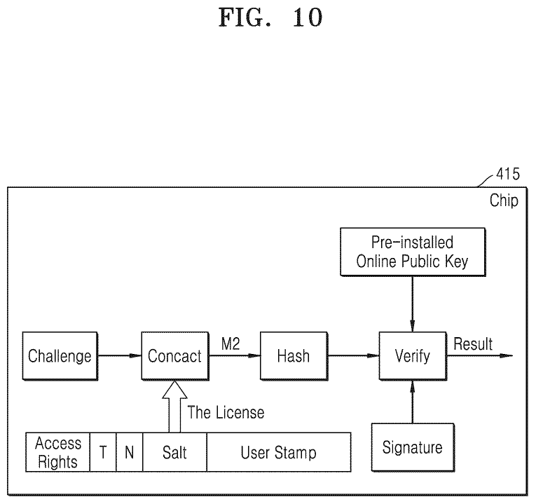

FIG. 10 is a diagram illustrating an example of verifying an authentication license according to an example embodiment of the present disclosure. Operations in FIG. 10 may correspond to step 710 in FIG. 7.

Referring to FIG. 10, the chip may concatenate the online challenge Challenge with the received authentication license (License_{received}) to obtain a concatenating result M2. The catenating result M2 may be written as M2=Challenge∥License_{received}. Then, the chip may verify whether the received signature (Signature_{received}) is the signature of hash value of M2 using the pre-installed online authentication public key as follows:
Result=Verify(online-pk, Hash(M2), Signature_{received}).

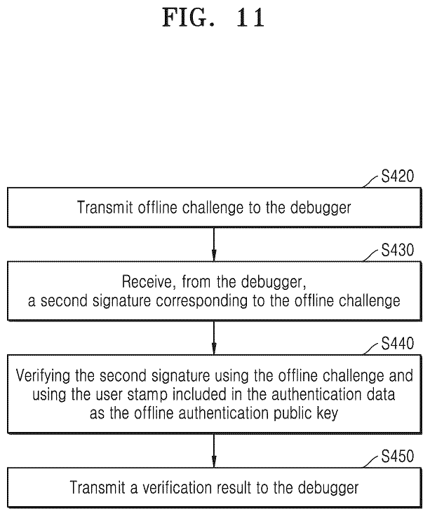

FIG. 11 is a flowchart of an offline authentication method according to an example embodiment of the present disclosure. The flowchart in FIG. 11 corresponds to step S400 in FIG. 3.

The following conditions may be satisfied when the offline authentication is performed: (1) the chip may pre-installed with an online authentication public key; (2) the chip may load the cycle tag, the authentication license License_{loaded} and its signature Signature_{loaded}, which may be generated in the online authentication; and (3) the debugger may load the salt Salt stored during the online authentication process. If these conditions are not satisfied, the offline authentication may fail and the user may not obtain debugging permission.

Referring to FIG. 11, in step S420, the chip may transmit an offline challenge to the debugger. In an example, the offline challenge may be a value generated based on the chip ID.

The debugger may derive the user private key (user-sk) from the user information (for example, user ID and password) and the salt Salt, and may sign the received offline challenge using the user private key, to generate a second signature.

In step S430, the chip may receive the second signature corresponding to the offline challenge from the debugger.

In step S440, the chip may verify the second signature using the offline challenge and using the user stamp included in the authentication license as the offline authentication public key.

In step S450, the chip may transmit a verification result to the debugger. For example, the debugger having received the verification result may run a debugging software tool, which may obtain code and data from the chip 415, control an operation of the code, and access or modify resources of the chip 415. When the offline authentication is successful, the chip 415 may enable the access rights of corresponding resources within the chip according to the access rights.

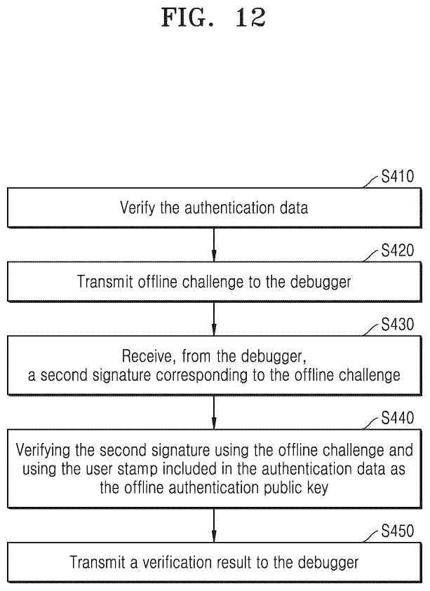

FIG. 12 is a flowchart of an offline authentication method according to another example embodiment of the present disclosure. The flowchart in FIG. 12 corresponds to step S400 in FIG. 3.

Referring to FIG. 11 and FIG. 12, steps S420 to S450 of FIG. 12 may be the same as steps S420 to S450 of FIG. 11, and repeated description may be omitted or simplified.

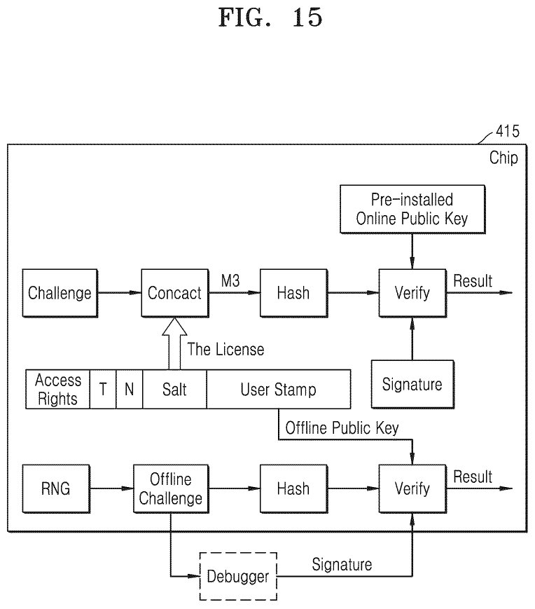

In order to inhibit or prevent malicious users from modifying the authentication license stored in the off-chip memory before the offline authentication, and to inhibit or prevent replay attacks, the authentication license loaded by the chip may be verified in step S410 after receiving the offline authentication request. In response to a successful verification of the authentication license, the offline challenge may be transmitted to the debugger in step S420. The operation of verifying authentication license will be described in detail with reference to FIG. 15.

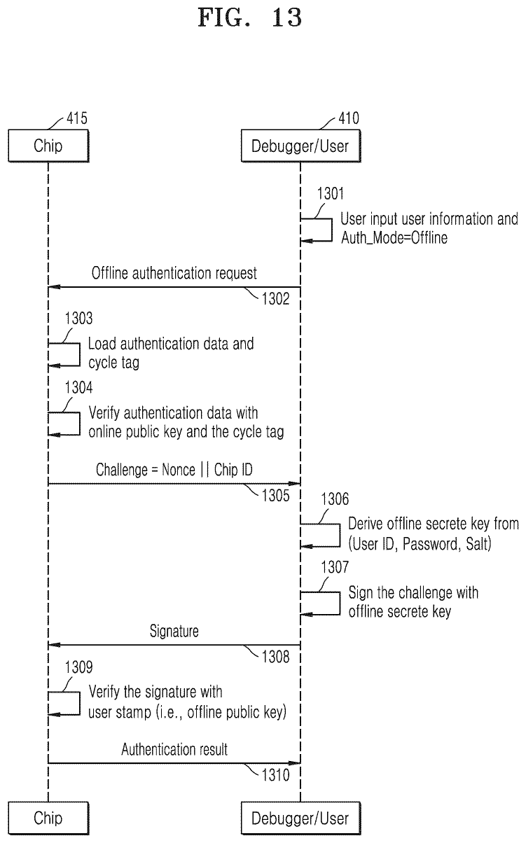

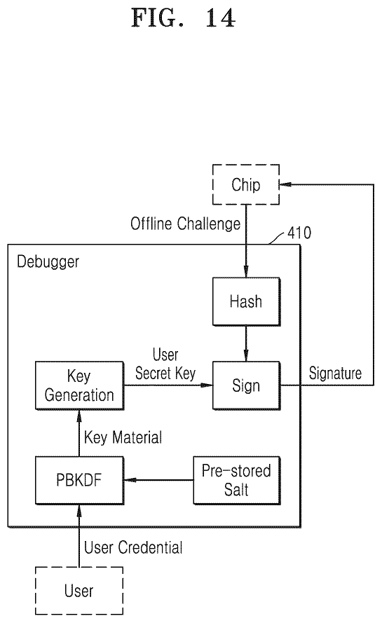

FIG. 13 is a diagram of an offline authentication method according to an example embodiment of the present disclosure. FIG. 14 is a diagram illustrating operations of a debugger during an offline authentication according to an example embodiment of the present disclosure. FIG. 15 is a diagram illustrating operations of a chip during an offline authentication according to an example embodiment of the present disclosure.

Referring to FIG. 13, in step 1301, a debugger may receive the user information and the authentication mode Auth_Mode from the user. The user information may include the user ID and the password, but this is only an example, and the present disclosure is not limited thereto. In response to the authentication mode being the offline mode, the debugger may determine that the user selects the offline authentication.

In step 1302, the debugger may transmit the offline authentication request to the chip.

At steps 1303 to 1304, the chip may verify the authentication license License_{loaded} loaded from the off-chip memory using the pre-installed online authentication public key. Steps 1303 to 1304 may correspond to step S410 in FIG. 12.

Referring to FIG. 15, the chip may read the cycle tag Cycle Tag from the on-chip memory, and may concatenate the cycle tag Cycle Tag with the loaded authentication license to obtain a concatenate result M3, wherein the concatenate result M3 may be written as M3=Cycle Tag∥License_{loaded}.

The chip may verify whether the loaded signature Signature_{loaded} corresponds to the hash value of M3 using the online authentication public key to as follows:
Result=Verify(online-pk, Hash(M3), Signature_{loaded}).

Referring back to FIG. 13, if the verification is successful, in step 1305, the chip may generate a random number Nonce, concatenate the random number Nonce with the chip ID to generate the offline challenge Challenge, and may transmit the offline challenge Challenge to the debugger. If the verification is not successful, the offline authentication may fail.

During steps 1306 to 1307, the debugger may sign the received offline challenge Challenge.

Referring to FIG. 14, the debugger may generate key material using the user ID, the password and the pre-stored salt through a password-based key derivation algorithm (for example, PBKDF2), generate a user private key (user-sk) based on the key material and the signature algorithm, and sign the received challenge Challenge using the private key as follows:
Signature=Sign(user-sk, Challenge)

After signing, the debugger may delete the private key. For example, by deleting the private key, a risk of revealing the private key may be reduced or eliminated.

Referring back to FIG. 13, in step 1308, the debugger may transmit the signature to the chip.

In step 1309, the chip may verify the received signature using the user stamp in the loaded authentication license as the offline authentication public key (offline-pk) as follows:
Result=Verify (offline-pk, Challenge, Signature)

If the authentication license belongs to the current user and the password is correct, the user private key user-sk derived from the user identity information (or the user credentials) in step 1306 is equal to the offline authentication private key offline-sk, which forms a pair with the user stamp in the authentication license (that is, the offline authentication public key offline-pk), and the signature verification will be successful. Other user IDs or wrong passwords may result in a mismatch between the derived user private key user-sk and the offline authentication public key offline-pk, which may cause failure of signature verification and failure of authentication.

In step 1310, the chip may transmit the authentication result to the debugger, and the offline authentication ends.

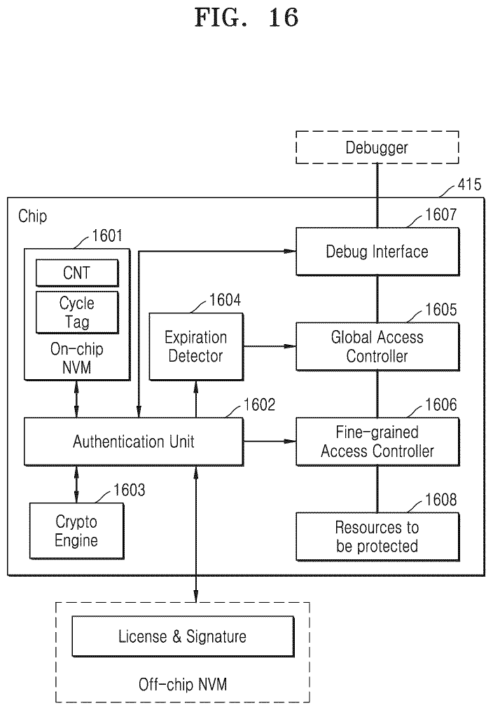

FIG. 16 is a diagram illustrating an example of a chip according to an example embodiment of the present disclosure.

Referring to FIG. 16, a chip 415 according to an example embodiment of the present disclosure may include an on-chip memory 1601, an authentication unit 1602, a cryptography engine 1603, an expiration detector 1604, and a global access controller 1605. In addition, the chip 415 may also include other modules, for example, a fine-grained access controller 1606, but the present disclosure is not limited thereto.

The revocation mechanism of debugging access authorization may be implemented by logic circuits within the chip 415.

Referring to FIG. 16, a two-level access controller may be provided between a debug interface 1607 and the resources 1608. The resource 1608 may be, for example, protected hardware resources. The first-level access controller may be implemented by the global access controller 1605. The global access controller 1605 may correspond to a master switch of the debug interface 1607. The global access controller 1605 is controlled by the expiration detector 1604. When expiration of the debugging access authorization is detected, the global access controller 1605 may disconnect the debug interface 1607 from the resources 1608 within the chip 415. At this time, the resources 1608 in the chip 415 cannot be accessed through the debug interface 1607 regardless of the authentication result. If the debugging access authorization has not expired, the global access controller 1605 may connect the debug interface 1607 with the resources 1608 within the chip 415, and the debugger disposed outside the chip 415 may be connected to the second-level access controller, such that a fine-grained access control may been implemented. For example, the second-level access controller may be implemented by the fine-grained access controller 1606.

The on-chip memory 1601 (for example, on-chip NVM) may be used to store the cycle tag Cycle Tag and the offline authentication count CNT. The on-chip memory 1601 may allow an access by the debugging authentication logic within the chip 415, and its pins may be unavailable to the outside. The cycle tag Cycle Tag and the offline authentication count CNT may only occupy a small memory space within the chip 415. For example, the cycle tag may be set to 16 to 32 bytes, and the offline authentication count may be set to 1 to 2 bytes.

The authentication unit 1602 may be an entity which performs the online authentication or offline authentication in the chip 415. The authentication unit 1602 may provide access rights information for the second-level access controller. The authentication unit 1602 may provide parameters for the expiration detector 1604. The authentication unit 1602 may trigger the expiration detector 1604 to update the parameters. The parameters may include an upper limit T of single power-on time of the chip 415, an upper limit N of cumulative offline authentication times, and the offline authentication count CNT, respectively. T and N may be extracted from the authentication license, which may be loaded from off-chip memory and may be verified by the authentication unit 1602 when performing the offline authentication. The parameter CNT may be obtained through loading from the on-chip memory 1601 and performing an addition operation by the authentication unit 1602 after completing the offline authentication.

A cryptography engine may be used to perform signature and verification operations in the chip 415. In some examples, the cryptography engine may be a portion of an authentication unit 1602.

According to the input validity period parameters T and N, a system clock and the offline authentication count CNT, the expiration detector 1604 may check and determine whether the debugging access authorization expires in real time, and may output an enable signal or a disable signal to the global access controller 1605, to connect or disconnect the debug interface 1607 with the resources 1608 within the chip 415.

The authentication license and its signature generated during the online authentication may be stored in the off-chip memory (for example, off-chip NVM) to save memory resources within the chip 415.

The debugger may be implemented by apparatuses, units, modules, devices, or other components. For example, the debugger may be a general purpose computer or an application specific computer. The debugger may be directly connected to the chip or connected to the chip via another device or component (e.g., a card reader or a printed circuit board). The debugger may be a distinct device from the chip 415, such that the debugger may be disposed outside of the chip 415. The debugger disposed outside the chip 415 may be distinct from the components of the chip 415, for example, may be disconnected from the chip 415. For example, the debugger disposed outside the chip 415 may rely on the debug interface 1607 for access to the chip 415.

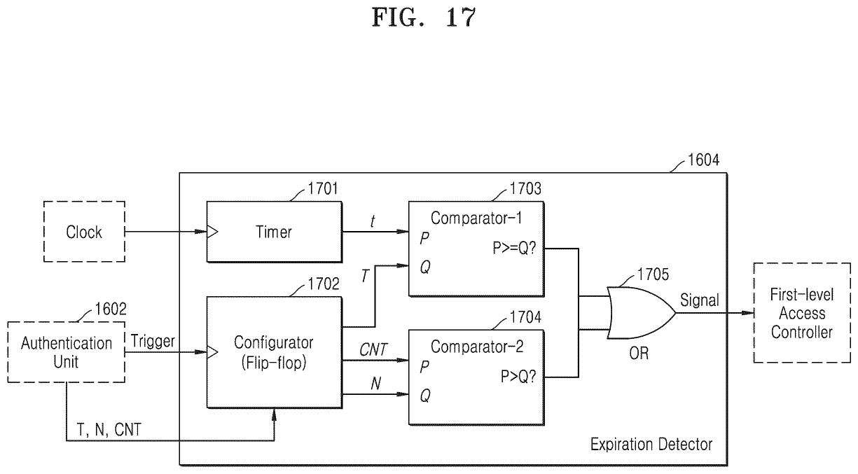

FIG. 17 is a diagram illustrating an example of a logic of an expiration detector 1604 according to an example embodiment of the present disclosure.

Referring to FIG. 17, a timer 1701 may generate a timing according to the input system clock signal Clock, and output a real-time count based on the timing. For example, if the timing is set to 5 s, the count output by the timer 1701 increases by 1 every 5 s. Every time the chip is powered on, the timer 1701 may start counting from 0, without saving the count value during the power-off period.

A configurator 1702 may correspond to a trigger, and both its input data and trigger signal may be from the authentication unit. The three parameters (T, N and CNT) output by the configurator may be transmitted to two comparators Comparator-1 1703 and Comparator-2 1704. If the chip is in an unauthenticated state after power-on, the configurator 1702 outputs T=0, N=0 and CNT=0 by default. t>=T will be satisfied from this time until the chip is authenticated. Therefore, the expiration detector 1604 may output a high level to the global access controller 1605 to disconnect the debug interface 1607. After the chip passes a successful authentication, the authentication unit 1602 may transmit T, N and CNT as parameters to the configurator 1702, and transmit a trigger signal Trigger to the configurator 1702, so that the configurator 1702 may gate the data to the output terminals.

The comparators Comparator-1 1703 and Comparator-2 1704 compare the input data P and Q. A rule of comparison of Comparator-1 1703 is to output a high level (i.e. 1) when P is greater than or equal to Q, otherwise to output a low level (i.e. 0). A rule of comparison of Comparator-2 1704 is to output a high level (i.e. 1) when P is greater than Q, otherwise to output a low level (i.e. 0). An OR gate OR 1705 may perform a logical OR operation on the output signals of the two comparators, and may generate a control signal of the first-level access controller implemented by the global access controller 1605.

An example of implementing revocation of debugging access authorization according to an example embodiment of the present disclosure is described hereinafter.

Assuming that a user needs to debug a solid state drive (SSD) control chip, which employs an online-offline authentication method described in the present disclosure.

During a first debugging, the user chooses an online mode. Alternatively, the online mode may be a default mode for the first debugging. After a successful online authentication, an authentication license may be obtained by the chip from the authentication server, the values of validity period parameters T and N may be 480 minutes and 50 attempts respectively, and an offline authentication count CNT stored in the chip may be 0. Assuming that a timing unit of the timer Timer is set to 1 minute, based on the validity period parameter T=480, the user may perform debugging for up to 480 minutes, regardless of the online authentication or offline authentication. If a timeout occurs, the user may no longer be able to access the debug interface. In addition, based on the validity period parameter N=50, the user may perform offline authentication for up to 50 times, until an online authentication needs to obtain a new configuration.

During a second debugging, the user may choose an offline mode. After a successful offline authentication, the offline authentication count CNT may increment to 1. Since the offline authentication count CNT is less than 50, the expiration detector may output a low level signal to the global access controller during the single power-on time t of the chip being counted from 0 to 479 minutes, which means that the user may perform debugging for up to about 8 hours. The user may turn off the power of the chip after debugging for 4 hours.

During a third debugging, the user may continue to choose the offline mode. After a successful offline authentication, the offline authentication count CNT may increment to 2. When the power-on time of the chip has passed 8 hours, the single power-on time t of the chip has accumulated to 480 minutes. At this time, the expiration detector detects an expiration event and triggers the global access controller to disconnect the debug interface from the chip resources. The user may want to continue the debugging, so the user may restart the chip, perform a new offline authentication, and the offline authentication count CNT may increment to 2. When the power-on time of the chip has passed 8 hours, the single power-on time 3. Thus, the user may have another 8 hours of debugging time.

In this manner, after performing the offline authentication for 50 times, when the user performs the offline authentication again, the offline authentication count CNT becomes 51, which is greater than N, which leads to an expiration event. The expiration detector triggers the global controller to disconnect the debug interface from the chip resources. The user may want to continue debugging, so the user may restart the chip for offline authentication. Although the authentication is successful, the offline authentication count CNT increments to 52, which triggers an expiration event, and the connection between the debug interface and chip resources is disconnected.

In order to continue debugging, it may be assumed that the user has applied for more debugging time and iterations from an authority, e.g., the manager of the server. After approval, it may be assumed that the user obtained a temporary permission to connect to the external network. After completing an online authentication, the chip obtains a new authentication license from the authentication server, where the values of T and N may be set to 600 minutes and 80 iterations respectively, which means that each debugging (online or offline) by the user may last up to 10 hours, and a total of 80 attempts at offline authentications may be carried out. Since the offline authentication count CNT may be cleared during the online authentication, the user may subsequently perform debugging normally through the offline authentication.

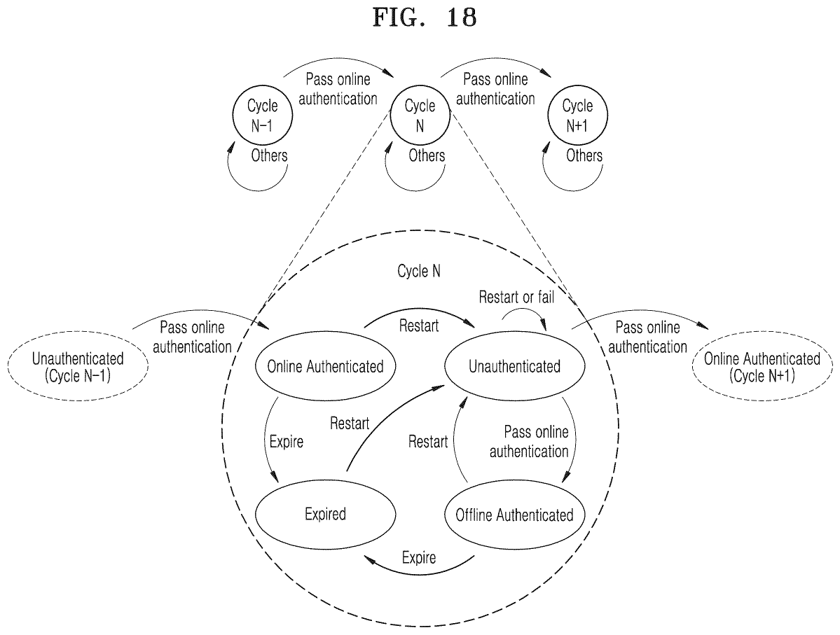

FIG. 18 is a diagram illustrating an example of authentication cycles according to an example embodiment of the present disclosure.

According to an example embodiment of the present disclosure, a chip may experience different states in the authentication process. The states in the authentication process may include: an unauthenticated state, an online authentication state, an offline authentication state, or an expired state. All the state transition processes between different online states may be called an Authentication Cycle.

Referring to FIG. 18, the unauthenticated state refers to a state in which the chip has not successfully passed debugging authentication after being powered on. In the unauthenticated state, if the chip receives an online authentication request, it may enter the online authentication state of a next authentication cycle; and if the chip receives an offline authentication request, it may enter the offline authentication state of this authentication cycle. After an expiration event is triggered, both the online and offline authentication states may be transitioned to the expired state of respective authentication cycles. In any one of the states, if the chip is restarted, it may enter the uncertified state of its authentication cycle.

According to an example embodiment of the present disclosure, the cycle tags Cycle Tag of different authentication cycles may be different from each other, which may ensure that the authentication licenses of different authentication cycles are not the same, thus effectively defending against a replay attack.

Even if the user ID and password don't change during the authentication cycles, the user stamps of one user in different authentication cycles may be different from each other. For example, the user stamps of one user in different authentication cycles may be different from each other because each authentication cycle may generate a new salt Salt, which may derive different offline authentication public keys (that is, user stamps) and offline authentication private keys due to different authentication cycles, and may improve security. Even if the debugger reveals the offline authentication private key, the private key may be used for a current authentication cycle and may be invalid in a next authentication cycle. For example, the private key may only be used for a current authentication cycle and may be invalid in a next authentication cycle.

The authentication method according to an example embodiment of the present disclosure may implement an authentication user identity-based. During the online authentication, the server may issue access authorization to an authenticated user, and may also generate a user stamp according to the user ID and password. The server may generate an authentication license using the user stamp together with the access authorization. The authentication license may be stored in an external memory of the chip to save memory resources within the chip. During the offline authentication later, the chip may perform authentication and authorization for user using previously stored authentication license. A user who has not been authenticated cannot be authorized even if the user may use the debugging environment (for example, the user may log in a debugging host or the server normally).

An authentication method according to an example embodiment of the present disclosure may assign a validity period for authorized access rights, and realize the revocation of the access rights based on the validity period. The authorized access rights together with its validity period parameters may form an authentication license and may be stored on the target chip, and the target chip may be responsible for detecting whether the access rights expire and determining whether to revoke the access rights. The validity parameters may be associated with the single power-on time t of the chip and the offline authentication times CNT. When any one of t≥T and CNT>n is satisfied, the access rights may be determined to be expired, which may make a scheme in which malicious users bypass the validity period by keeping the chip powered on or resetting the timer invalid. The expired state may be cleared and the authentication and authorization functions be restored by performing an online authentication again. For example, only by performing an online authentication again, may the expired state be cleared and the authentication and the authorization functions be restored.

An authentication method according to an example embodiment of the present disclosure may effectively defend against replay attacks. Because the authorization information in different authentication cycles may be attached with different cycle tags Cycle Tag, the chip may invalidate all authorization information in historical authentication cycles, and defend against replay attacks. In addition, the system may have higher security because the user stamps in different authentication cycles may be different.

In an example, a malicious user (or an attacker) tampers with the stored authentication license before an offline authentication so as to change their rights. According to an example embodiment of the present disclosure, during the offline authentication, the chip may verify the signature of the authentication license with a pre-installed online authentication public key (online-pk), therefore, the authentication license tampered by the attacker may lead to a failure of signature verification. In addition, the attacker cannot forge a signature for the revised authentication license, because the attacker cannot obtain the online authentication private key on the server.

In an example, a malicious user tampers with the stored authentication license after a successful offline authentication in order to change their own rights. According to an example embodiment of the present disclosure, since the tampering occurs after the user passes the offline authentication, it may not be detected through the signature verification operation temporarily. However, the tampered authentication license may be in a stored status, and not loaded into the system. Only after an authentication is performed again, the stored authentication license may be loaded into the system, and this step may include verifying that the authentication license have been tampered.

In an example, a malicious user may back up the authentication license and its signatures in the chip after a certain successful authentication, and then writes the backed-up authentication license and its signature in the chip later in order to restore rights for the chip. According to an example embodiment of the present disclosure, because each authentication cycle may use a cycle tag Cycle Tag to uniquely mark the authentication license and the cycle tag Cycle Tag participates in the verifying of signature of the authentication license, even if the online authentication public key remains unchanged, the historical authentication license may not pass the current authentication.

An authentication method according to an example embodiment of the present disclosure occupies limited chip resources. Although some logic units on the chip may be deployed and occupy some internal and external memory space of the chip, a resource usage may be low. For example, a main resource overhead of an authentication method according to an example embodiment of the present disclosure may result from a cryptography calculation during the authentication, and the chip may only involve the verification of the signature. Therefore, the cryptography calculation may be performed using a built-in cryptography engine in the chip without additional circuits. Other logic in an authentication method according to an example embodiment of the present disclosure and the expiration detector may be implemented only by simple logic gate circuits. In addition, the authentication license may be stored in the off-chip memory of the chip, which does not occupy the chip's resources. Although the cycle tag Cycle Tag and the offline authentication count CNT may be stored in the on-chip memory, they are small.

Apparatuses, units, modules, devices, and other components described herein may be implemented by hardware components. Examples of hardware components that may be used to perform operations described in this application where appropriate may include controllers, sensors, generators, drivers, memories, comparators, arithmetic logic units, adders, subtractors, multipliers, dividers, integrators, or any other electronic components. These and other hardware components may be configured to perform operations described in this application. In other examples, one or more of the hardware components that perform operations described in this application may be implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices. These processing elements may be configured to respond to and execute instructions in a defined manner to achieve a desired result. In an example, a processor or computer may include, or may be connected to, one or more memories storing instructions or software that may be executed by the processor or computer. Hardware components implemented by a processor or computer may execute instructions or software, such as an operating system (OS) and one or more software applications that run on the OS, to perform operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, or multiple-instruction multiple-data (MIMD) multiprocessing.

Methods that perform operations described in this application may be performed by computing hardware, for example, by one or more processors or computers, implemented as described herein executing instructions or software to perform operations described in this application. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement hardware components and perform methods as described herein may be written as computer programs, code segments, instructions or any combination thereof, for singlely or collectively instructing or configuring the processor or computer to operate as a machine or special-purpose computer to perform operations performed by hardware components and methods as described herein. In an example, instructions and/or software include machine code may be directly executed by a processor or computer, such as machine code produced by a compiler. In another example, instructions or software may include higher-level code that may be executed by a processor or computer using an interpreter. Persons and/or programmers of normal skill in the art may readily write instructions and/or software based on the block diagrams and the flow charts illustrated in the drawings and the corresponding descriptions in the specification, which disclose algorithms for performing operations performed by hardware components and methods as described herein.

Instructions or software to control a processor or computer to implement hardware components and perform methods as described herein, and any associated data, data files, and data structures, may be recorded, stored, or fixed in or on one or more non-transitory computer-readable storage media. Examples of a non-transitory computer-readable storage medium include at least one of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), SSD, flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, or any other device that may be configured to store instructions or software and any associated data, data files, and data structures in a non-transitory manner and providing instructions or software and any associated data, data files, and data structures to a processor or computer so that the processor or computer can execute the instructions.

While various example embodiments have been described, it will be apparent to one of normal skill in the art that various changes in form and details may be made in these examples without departing from the spirit and scope of the claims and their equivalents.

What is claimed is:

1. An authentication method performed by a chip, the authentication method comprising:
receiving an authentication request from a debugger;
performing an offline authentication based on an authentication license in response to the authentication request being an offline authentication request, wherein the authentication license includes access control information of a chip and a user stamp generated based on user information; and
enabling access of the debugger to a resource of the chip based on the access control information,
wherein the performing of the offline authentication comprises:
transmitting an offline challenge to the debugger, wherein the offline challenge is generated by the chip based on an identifier of the chip,
receiving, from the debugger, a second signature corresponding to the offline challenge, and
verifying the second signature based on the offline challenge, using the user stamp included in the authentication license as an offline authentication public key.

2. The method of claim 1, wherein the performing of the offline authentication further comprises:
verifying the authentication license after receiving the offline authentication request; and
transmitting the offline challenge to the debugger, in response to the verifying of the authentication license.

3. The method of claim 2, wherein the verifying of the authentication license comprises:
concatenating a cycle tag with the authentication license to form a first concatenating result; and
verifying that a first signature corresponds to a hash value of the first concatenating result using a pre-installed online authentication public key.

4. The method of claim 1, wherein the authentication license further comprises a first validity period parameter and a second validity period parameter, and
wherein access rights of the debugger to the resource of the chip are disabled in response to at least one of an single power-on time of the chip being greater than or equal to the first validity period parameter or an offline authentication count value being greater than or equal to the second validity period parameter.

5. The method of claim 4, further comprising resetting the offline authentication count value in response to an online authentication being performed, and
wherein the offline authentication count value is increased by 1 in response to the offline authentication being performed.

6. The method of claim 1, further comprising transmitting a verification result to the debugger.

7. A method of authenticating a chip comprising:
receiving, by the chip, an authentication request from a debugger;
performing an online authentication, in response to the authentication request being an online authentication request; and
enabling access of the debugger to a resource of the chip based on the online authentication,
wherein the performing of the online authentication comprises:
transmitting an online challenge from the chip to the debugger, wherein the online challenge is generated based on an identifier of the chip;
receiving, by the chip from the debugger, an authentication license and a first signature generated by a server;
verifying, by the chip, the first signature using a pre-installed online authentication public key; and
storing, by the chip, the authentication license and the first signature in an off-chip memory, and storing the online challenge as a cycle tag in an on-chip memory, in response to the verifying of the first signature.

8. The method of claim 7, wherein the authentication license is generated by the server based on the online challenge and user information and includes a user stamp as a public key generated based on the user information and a salt, and
wherein the first signature is generated by the server signing a concatenating result of the online challenge and the authentication license using an online authentication private key.

9. The method of claim 8, the verifying of the first signature comprises:
concatenating, by the chip, the online challenge with the received authentication license to form the first concatenating result (M2); and
verifying, by the chip, that the first signature corresponds to a hash value of the first concatenating result using the pre-installed online authentication public key.

10. The method of claim 7, wherein the authentication license further comprises a first validity period parameter and a second validity period parameter, and
wherein access rights of the debugger to the resource of the chip are disabled in response to at least one of an single power-on time of the chip being greater than or equal to the first validity period parameter or an offline authentication count value being greater than or equal to the second validity period parameter.

11. The method of claim 7, wherein an offline authentication count value is reset in response to the online authentication being performed, and
wherein the offline authentication count value is increased by 1 in response to an offline authentication being performed.

12. The method of claim 7, further comprising transmitting, by the chip, a verification result to the debugger.

13. A chip comprising:
an on-chip memory;
an authentication unit configured to receive an authentication request from a debugger and perform an offline authentication based on an authentication license generated through an online authentication, in response to the authentication request being an offline authentication request, wherein the authentication license includes access control information of the chip and a user stamp generated based on user information; and
a global access controller configured to enable access rights of the debugger to a resource of the chip based on the access control information, after the authentication is successful,
wherein, for the performing of the offline authentication, the authentication unit is configured to:
transmit an offline challenge to the debugger, wherein the offline challenge is generated based on an identifier of the chip,
receive, from the debugger, a second signature corresponding to the offline challenge, and
verify the second signature based on the offline challenge, using the user stamp included in the authentication license as an offline authentication public key.

14. The chip of claim 13, wherein for the performing of the offline authentication, the authentication unit is further configured to:
verify the authentication license after receiving the offline authentication request; and
transmit the offline challenge to the debugger in response to a verification of the authentication license.

15. The chip of claim 14, wherein for the verifying of the authentication license, the authentication unit is configured to:
concatenate a cycle tag generated by the online authentication with the authentication license, to form a first concatenating result, and
verify whether a first signature corresponds to a hash value of the first concatenating result, using a pre-installed online authentication public key, and
wherein the first signature is generated by a server during the online authentication.

16. The chip of claim 15, wherein the authentication unit is further configured to:
perform an online authentication, in response to the authentication request being an online authentication request,
wherein the authentication license and the first signature corresponding to the authentication license are saved when the online authentication is successful.

17. The chip of claim 16, wherein for the performing of the online authentication, the authentication unit is configured to:
transmit an online challenge to the debugger, wherein the online challenge is generated based on the identifier of the chip;
receive, from the debugger, the authentication license and the first signature generated by a server;
verify the first signature using a pre-installed online authentication public key;
store the authentication license and the first signature in an off-chip memory, and store the online challenge as the cycle tag in the on-chip memory, in response to successful verification of the first signature; and
transmit a verification result to the debugger.

18. The chip of claim 16, wherein the authentication license is generated by the server based on the user information,
wherein the first signature is generated by the server signing a concatenating result of the online challenge and the authentication license using an online authentication private key, and
wherein the user stamp is a public key generated by the server based on the user information and a salt.

19. The chip of claim 18, wherein for the verifying of the first signature, the authentication unit is configured to:
concatenate the online challenge with the received authentication license to form the first concatenating result; and
verify whether the first signature corresponds to the hash value of the first concatenating result using the pre-installed online authentication public key.

20. The chip of claim 13, wherein the authentication license further comprise a first validity period parameter and a second validity period parameter, and
wherein the access rights of resources within the chip are disabled, in response to an single power-on time of the chip being greater than or equal to the first validity period parameter, and/or an offline authentication count value being greater than or equal to the second validity period parameter.
